(19) United States
(12) Patent Application Publication
(10) Pub. No.: US 2013/0268941 A1
(43) Pub. Date: Oct. 10, 2013

(54) DETERMINING AN ALLOCATION OF RESOURCES TO ASSIGN TO JOBS OF A PROGRAM

(71) Applicants: LUDMILA CHERKASOVA, Sunnyvale, CA (US); Abhishek Verma, Champaign, IL (US); Zhuoyao Zhang, Philadelphia, PA (US)

(72) Inventors: LUDMILA CHERKASOVA, Sunnyvale, CA (US); Abhishek Verma, Champaign, IL (US); Zhuoyao Zhang, Philadelphia, PA (US)

(21) Appl. No.: 13/442,358

(22) Filed: Apr. 9, 2012

(51) Int. Cl. G06F 9/50

(52) U.S. Cl. 718/104

(57) ABSTRACT

A performance model is used to calculate a performance parameter based on characteristics of a collection of jobs that make up a program, a number of map tasks in the jobs, a number of reduce tasks in the jobs, and an allocation of resources, where the jobs include the map tasks and the reduce tasks, the map tasks producing intermediate results based on segments of input data, and the reduce tasks producing an output based on the intermediate results. Using a value of the performance parameter calculated by the performance model, a particular allocation of resources is determined to assign to the jobs of the program to meet a performance goal of the program.

### BACKGROUND

Computing services can be provided by a network of resources, which can include processing resources and storage resources. The network of resources can be accessed by various requestors. In an environment that can have a relatively large number of requestors, there can be competition for the resources.

### BRIEF DESCRIPTION OF THE DRAWINGS

Some embodiments are described with respect to the following figures:

FIG. 1 is a block diagram of an example arrangement that incorporates some implementations;

FIG. 2 is a graph of an example arrangement of jobs, for which resource allocation is to be performed according to some implementations;

FIG. 3 is a flow diagram of a resource allocation process according to some implementations; and

FIGS. 4A-4B are graphs illustrating feasible solutions representing respective allocations of map slots and reduce slots, determined according to some implementations.

### DETAILED DESCRIPTION

To process data sets in a network environment that includes computing and storage resources, a MapReduce framework can be provided, where the MapReduce framework provides a distributed arrangement of machines to process requests performed with respect to the data sets. A MapReduce framework is able to process unstructured data, which refers to data not formatted according to a format of a relational database management system. An open-source implementation of the MapReduce framework is Hadoop.

Generally, a MapReduce framework includes a master node and multiple slave nodes (also referred to as worker nodes). A MapReduce job submitted to the master node is divided into multiple map tasks and multiple reduce tasks, which can be executed in parallel by the slave nodes. The map tasks are defined by a map function, while the reduce tasks are defined by a reduce function. Each of the map and reduce functions can be user-defined functions that are programmable to perform target functionalities.

MapReduce jobs can be submitted to the master node by various requestors. In a relatively large network environment, there can be a relatively large number of requestors that are contending for resources of the network environment. Examples of network environments include cloud environments, enterprise environments, and so forth. A cloud environment provides resources that are accessible by requestors over a cloud (a collection of one or multiple networks, such as public networks). An enterprise environment provides resources that are accessible by requestors within an enterprise, such as a business concern, an educational organization, a government agency, and so forth.

Although reference is made to a MapReduce framework or system in some examples, it is noted that techniques or mechanisms according to some implementations can be applied in other distributed processing frameworks that employ map tasks and reduce tasks. More generally, “map tasks” are used to process input data to output intermediate results, based on a predefined map function that defines the processing to be performed by the map tasks. “Reduce tasks” take as input partitions of the intermediate results to produce outputs, based on a predefined reduce function that defines the processing to be performed by the reduce tasks. The map tasks are considered to be part of a map stage, whereas the reduce tasks are considered to be part of a reduce stage. In addition, although reference is made to unstructured data in some examples, techniques or mechanisms according to some implementations can also be applied to structured data formatted for relational database management systems.

Map tasks are run in map slots of slave nodes, while reduce tasks are run in reduce slots of slave nodes. The map slots and reduce slots are considered the resources used for performing map and reduce tasks. A “slot” can refer to a time slot or alternatively, to some other share of a processing resource or storage resource that can be used for performing the respective map or reduce task.

More specifically, in some examples, the map tasks process input key-value pairs to generate a set of intermediate key-value pairs. The reduce tasks (based on the reduce function) produce an output from the intermediate results. For example, the reduce tasks merge the intermediate values associated with the same intermediate key.

The map function takes input key-value pairs (k₁, v₁) and produces a list of intermediate key-value pairs (k₂, v₂). The intermediate values associated with the same key k₂ are grouped together and then passed to the reduce function. The reduce function takes an intermediate key k₂ with a list of values and processes them to form a new list of values (v₃), as expressed below.

map(k₁, v₁)→list(k₂, v₂) reduce(k₂, list(v₂))→list(v₃)

The multiple map tasks and multiple reduce tasks (of multiple jobs) are designed to be executed in parallel across resources of a distributed computing platform.

In a relatively complex or large system, it can be relatively difficult to efficiently allocate resources to jobs and to schedule the tasks of the jobs for execution using the allocated resources, while meeting corresponding performance goals.

In a network environment that provides services accessible by requestors, it may be desirable to support a performance-driven resource allocation of network resources shared across multiple requestors running data-intensive programs. A program to be run in a MapReduce system may have a performance goal, such as a completion time goal, cost goal, or other goal, by which results of the program are to be provided to satisfy a service level objective (SLO) of the program.

In some examples, the programs to be executed in a MapReduce system can include Pig programs. Pig provides a high-level platform for creating MapReduce programs. In some examples, the language for the Pig platform is referred to as Pig Latin, where Pig Latin provides a declarative language to allow for a programmer to write programs using a high-level programming language. Pig Latin combines the high-level declarative style of SQL (Structured Query Language) and the low-level procedural programming of MapReduce. The declarative language can be used for defining data analysis tasks. By allowing programmers to use a declarative programming language to define data analysis tasks, the programmer does not have to be concerned with defining map functions and reduce functions to perform the data analysis tasks, which can be relatively complex and time-consuming.

Although reference is made to Pig programs, it is noted that in other examples, programs according to other declarative languages can be used to define data analysis tasks to be performed in a MapReduce system.

In accordance with some implementations, mechanisms or techniques are provided to specify efficient allocations of resources in a MapReduce system to jobs of a program, such as a Pig program or other program written in a declarative language. In the ensuing discussion, reference is made to Pig programs—however, techniques or mechanisms according to some implementations can be applied to programs according to other declarative languages.

Given a Pig program with a given performance goal, such as a completion time goal, cost goal, or other goal, techniques or mechanisms according to some implementations are able to estimate an amount of resources (a number of map slots and a number of reduce slots) to assign for completing the Pig program according to the given performance goal. The allocated number of map slots and number of reduce slots can then be used by the jobs of the Pig program for the duration of the execution of the Pig program.

To perform the resource allocation, a performance model can be developed to allow for the estimation of a performance parameter, such as a completion time or other parameter, of a Pig program as a function of allocated resources (allocated number of map slots and allocated number of reduce slots).

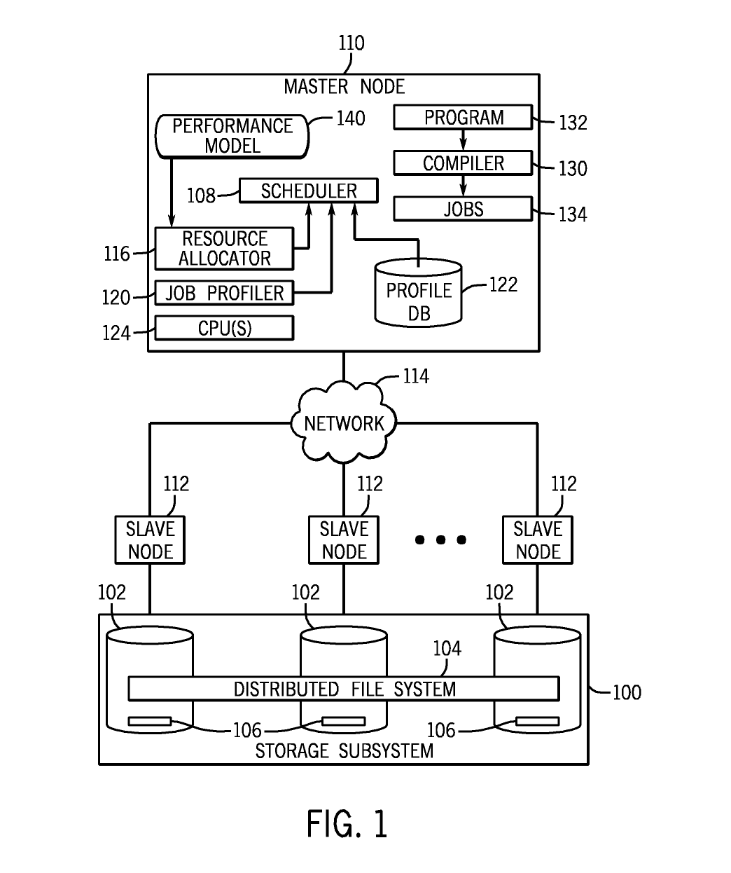

FIG. 1 illustrates an example arrangement that provides a distributed processing framework that includes mechanisms according to some implementations. As depicted in FIG. 1, a storage subsystem 100 includes multiple storage modules 102, where the multiple storage modules 102 can provide a distributed file system 104. The distributed file system 104 stores multiple segments 106 of data across the multiple storage modules 102. The distributed file system 104 can also store outputs of map and reduce tasks.

The storage modules 102 can be implemented with storage devices such as disk-based storage devices or integrated circuit or semiconductor storage devices. In some examples, the storage modules 102 correspond to respective different physical storage devices. In other examples, plural ones of the storage modules 102 can be implemented on one physical storage device, where the plural storage modules correspond to different logical partitions of the storage device.

The system of FIG. 1 further includes a master node 110 that is connected to slave nodes 112 over a network 114. The network 114 can be a private network (e.g. a local area network or wide area network) or a public network (e.g. the Internet), or some combination thereof The master node 110 includes one or multiple central processing units (CPUs) 124. Each slave node 112 also includes one or multiple CPUs (not shown). Although the master node 110 is depicted as being separate from the slave nodes 112, it is noted that in alternative examples, the master node 112 can be one of the slave nodes 112.

A “node” refers generally to processing infrastructure to perform computing operations. A node can refer to a computer, or a system having multiple computers. Alternatively, a node can refer to a CPU within a computer. As yet another example, a node can refer to a processing core within a CPU that has multiple processing cores. More generally, the system can be considered to have multiple processors, where each processor can be a computer, a system having multiple computers, a CPU, a core of a CPU, or some other physical processing partition.

In accordance with some implementations, a scheduler 108 in the master node 110 is configured to perform scheduling of jobs on the slave nodes 112. The slave nodes 112 are considered the working nodes within the cluster that makes up the distributed processing environment.

Each slave node 112 has a corresponding number of map slots and reduce slots, where map tasks are run in respective map slots, and reduce tasks are run in respective reduce slots. The number of map slots and reduce slots within each slave node 112 can be preconfigured, such as by an administrator or by some other mechanism. The available map slots and reduce slots can be allocated to the jobs.

The slave nodes 112 can periodically (or repeatedly) send messages to the master node 110 to report the number of free slots and the progress of the tasks that are currently running in the corresponding slave nodes.

Each map task processes a logical segment of the input data that generally resides on a distributed file system, such as the distributed file system 104 shown in FIG. 1. The map task applies the map function on each data segment and buffers the resulting intermediate data. This intermediate data is partitioned for input to the reduce tasks.

The reduce stage (that includes the reduce tasks) has three phases: shuffle phase, sort phase, and reduce phase. In the shuffle phase, the reduce tasks fetch the intermediate data from the map tasks. In the sort phase, the intermediate data from the map tasks are sorted. An external merge sort is used in case the intermediate data does not fit in memory. Finally, in the reduce phase, the sorted intermediate data (in the form of a key and all its corresponding values, for example) is passed on the reduce function. The output from the reduce function is usually written back to the distributed file system 104.

As further shown in FIG. 1, the master node 110 includes a compiler 130 that is able to compile (translate or convert) a Pig program 132 into a collection 134 of MapReduce jobs. The Pig program 132 may have been provided to the master node 110 from another machine, such as a client machine (a requestor). As noted above, the Pig program 132 can be written in Pig Latin. A Pig program can specify a query execution plan that includes a sequence of steps, where each step specifies a corresponding data transformation task.

The master node 110 of FIG. 1 further includes a job profiler 120 that is able to create a job profile for each job in the collection 134 of jobs. A job profile describes characteristics of map and reduce tasks of the given job to be performed by the system of FIG. 1. A job profile created by the job profiler 120 can be stored in a job profile database 122. The job profile database 122 can store multiple job profiles, including job profiles of jobs that have executed in the past.

The master node 110 also includes a resource allocator 116 that is able to allocate resources, such as numbers of map slots and reduce slots, to jobs of the Pig program 132, given a performance goal (e.g. target completion time) associated with the Pig program 132. The resource allocator 116 receives as input jobs profiles of the jobs in the collection 134. The resource allocator 116 also uses a performance model 140 that calculates a performance parameter (e.g. time duration of a job) based on the characteristics of a job profile, a number of map tasks of the job, a number of reduce tasks of the job, and an allocation of resources (e.g. number of map slots and number of reduce slots).

Using the performance parameter calculated by the performance model 140, the resource allocator 116 is able to determine feasible allocations of resources to assign to the jobs of the Pig program 132 to meet the performance goal associated with the Pig program 132. As noted above, in some implementations, the performance goal is expressed as a target completion time, which can be a target deadline or a target time duration, by or within which the job is to be completed. In such implementations, the performance parameter that is calculated by the performance model 140 is a time duration value corresponding to the amount of time the jobs would take assuming a given allocation of resources. The resource allocator 116 is able to determine whether any particular allocation of resources can meet the performance goal associated with the Pig program 132 by comparing a value of the performance parameter calculated by the performance model to the performance goal.

The numbers of map slots and numbers of reduce slots allocated to respective jobs can be provided by the resource allocator 116 to the scheduler 108. The scheduler 108 is able to listen for events such as job submissions and heartbeats from the slave nodes 118 (indicating availability of map and/or reduce slots, and/or other events). The scheduling functionality of the scheduler 108 can be performed in response to detected events.

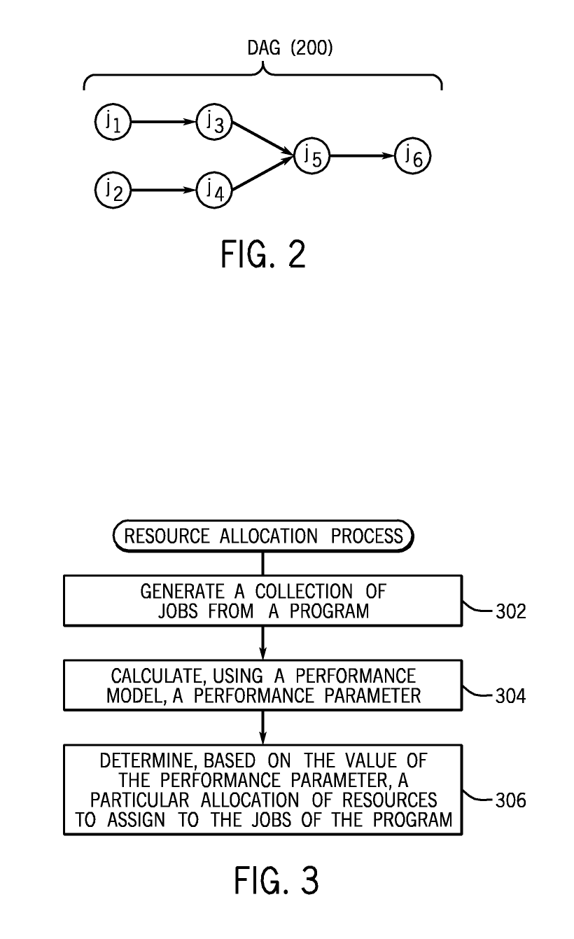

In some implementations, the collection 134 of jobs produced by the compiler 130 from the Pig program 132 can be a directed acyclic graph (DAG) of jobs. A DAG is a directed graph that is formed by a collection of vertices and directed edges, where each edge connects one vertex to another vertex. The DAG of jobs specify an ordered sequence, in which some jobs are to be performed earlier than other jobs, while certain jobs can be performed in parallel with certain other jobs. FIG. 2 shows an example DAG 200 of five MapReduce jobs {j₁, j₂, j₃, j₄, j₅}, where each vertex in the DAG 200 represents a corresponding MapReduce job, and the edges between the vertices represent the data dependencies between jobs.

To execute the plan represented by the DAG 200 of FIG. 2, the scheduler 108 can submit all the ready jobs (the jobs that do not have data dependency on other jobs) to the slave nodes. After the slave nodes have processed these jobs, the scheduler 108 can delete those jobs and the corresponding edges from the DAG, and can identify and submit the next set of ready jobs. This process continues until all the jobs are completed. In this way, the scheduler 108 partitions the DAG 200 into multiple stages, each containing one or multiple independent MapReduce jobs that can be executed concurrently.

For example, the DAG 200 shown in FIG. 2 can be partitioned into the following four stages for processing:

first stage: {j₁, j₂};

second stage: {j₃, j₄};

third stage: {j₅};

fourth stage: {j₆}.

In other examples, instead of representing a collection of jobs as a DAG, the collection of jobs can be represented using another type of data structure that provides a representation of an ordered arrangement of jobs that make up a program.

FIG. 3 is a flow diagram of a resource allocation process according to some implementations, which can be performed by the master node 110 of FIG. 1, for example. The process includes generating (at 302) a collection of jobs from a program, such as the Pig program 132 of FIG. 1. The generating can be performed by the compiler 130 of FIG. 1. As noted above, the collection of jobs can be a DAG of jobs (e.g. 200 in FIG. 2). Each job of the collection can include a map task (or map tasks) and a reduce task (or reduce tasks).

The process calculates (at 304) a performance parameter using a performance model (e.g. 140 in FIG. 1) based on the characteristics of the jobs, a number of the map tasks in the jobs, a number of reduce tasks in the jobs, and an allocation of resources.

The process then determines (at 306), based on the value of the performance parameter calculated by the performance model, a particular allocation of resources to assign to the jobs of the program to meet a performance goal of the program. Task 306 can be performed by the resource allocator 116.

Given the allocation of resources to assign to the jobs of the program, the scheduler 108 of FIG. 1 can schedule the jobs for execution on the slave nodes 112 of FIG. 1 (using available map and reduce slots of the slave nodes 112).

Further details of the performance model (e.g. 140 of FIG. 1) are provided below. In some implementations, the performance model evaluates lower, upper, or intermediate (e.g. average) bounds on a target completion time. The performance model can be based on a general model for computing performance bounds on the completion time of a given set of n (where n≧1) tasks that are processed by k (where k≧1) nodes, (e.g. n map or reduce tasks are processed by k map or reduce slots in a MapReduce environment). Let T₁, T₂, . . . , Tₙ be the duration of n tasks in a given set. Let k be the number of slots that can each execute one task at a time. The assignment of tasks to slots can be performed using an online, greedy techique: assign each task to the slot which finished its running task the earliest. Let avg and max be the average and maximum duration of the n tasks respectively. Then the completion time of a task can be at least:

$${T}^{low} = avg \cdot \frac{n}{k} , \\ and at most$$

$${T}^{up} = avg \cdot \frac{( n - 1 )}{k} + max .$$

The difference between lower and upper bounds represents the range of possible completion times due to task scheduling non-determinism (based on whether the maximum duration task is scheduled to run last). Note that these lower and upper bounds on the completion time can be computed if the average and maximum durations of the set of tasks and the number of allocated slots is known.

To approximate the overall completion time of a job J, the average and maximum task durations during different execution phases of the job are estimated. The phases include map, shuffle/sort, and reduce phases. Measurements such as M_{avg}^{J} and Mₘₐₓ^{J} (R_{avg}^{J} and Rₘₐₓ^{J}) of the average and maximum map (reduce) task durations for a job J can be obtained from execution logs (logs containing execution times of previously executed jobs). By applying the outlined bounds model, the completion times of different processing phases (map, shuffle/sort, and reduce phases) of the job are estimated.

For example, let job J be partitioned into N_{M}^{J} map tasks. Then the lower and upper bounds on the duration of the map stage in the future execution with S_{M}^{J} map slots (the lower and upper bounds are denoted as T_{M}^{low} and T_{M}^{up} respectively) are estimated as follows:

$$\begin{matrix}{T}_{M}^{low} = {M}_{avg}^{J} \cdot {N}_{M}^{J} / {S}_{M}^{J} , & ( Eq . 1 ) \\ {T}_{M}^{up} = {M}_{avg}^{J} \cdot \frac{{N}_{M}^{J} - 1}{{s}_{M}^{J}} + {M}_{max}^{J} . & ( Eq . 2 )\end{matrix}$$

Similarly, bounds of the execution time of other processing phases (shuffle/sort and reduec phases) of the job can be computed. As a result, the estimates for the entire job completion time (lower bound T_{J}^{low} and upper bound Tⱼ^{up}) can be expressed as a function of allocated map and reduce slots (S_{M}^{J}, S_{R}^{J}) using the following equation:

$${T}_{J}^{low} = \frac{{A}_{J}^{low}}{{s}_{M}^{J}} + \frac{{B}_{J}^{low}}{{s}_{R}^{J}} + {C}_{J}^{low} . \qquad ( Eq . 3 )$$

The equation for T_{J}^{up} can be written in a similar form. The average (T_{J}^{avg}) of lower and upper bounds (average of T_{J}^{low} and T_{J}^{up}) can provide an approximation of the job completion time.

Once a technique for predicting the job completion time (using the performance model discussed above to compute an upper bound, lower bound, or intermediate of the completion time) is provided, it also can be used for solving the inverse problem: finding the appropriate number of map and reduce slots that can support a given job deadline D. For example, by setting the left side of Eq. 3 to deadline D, Eq. 4 is obtained with two variables S_{M}^{J} and S_{R}^{J}:

$$D = \frac{{A}_{J}^{low}}{{s}_{M}^{J}} + \frac{{B}_{J}^{low}}{{s}_{R}^{J}} + {C}_{J}^{low} \qquad ( Eq . 4 )$$

Using the performance model of a single job as a building block, as described above, a performance model for the jobs of a Pig program P (which can be compiled into a collection of |P| jobs, P={J₁, J₂, . . . J_{|P|}}) can be derived, as discussed below.

For each job Jᵢ(1≦i≦|P|) that constitutes a program P, in addition to the number of map (N_{M}^{J}^{ᵢ}) and reduce (N_{R}^{J}^{ᵢ}) tasks, metrics that reflect durations of map and reduce tasks (note that shuffle phase measurements can be included in reduce task measurements) can be derived:

(M_{avg}^{J}^{ᵢ}, Mₘₐₓ^{J}^{ᵢ}, AvgSize_{M}^{J}^{ᵢ}^{input}, Selectivity_{M}^{J}^{ᵢ}),

(R_{avg}^{J}^{ᵢ}, Rₘₐₓ^{J}^{ᵢ}. Selectivity_{R}^{J}^{ᵢ}).

M_{avg}_hu J^{ᵢ} and Mₘₐₓ^{J}^{ᵢ} represent the average and maximum map task durations, respectively, for the job Jᵢ, and R_{avg}^{J}^{ᵢ} and Rₘₐₓ^{J}^{ᵢ} represent the average and maximum map reduce durations, respectively, for the job Jᵢ. AvgSize_{M}^{J}^{ᵢ}^{input} is the average amount of input data per map task of job Jᵢ (which is used to estimate the number of map tasks to be spawned for processing a dataset). Selectivity_{M}^{J}^{ᵢ} and Selectivity_{R}^{J}^{ᵢ} refer to the ratios of the map and reduce output sizes, respectively, to the map input size. Each of the parameters is used to estimate the amount of intermediate data produced by the map (or reduce) stage of job Jᵢ, which allows for the estimation of the size of the input dataset for the next job in the DAG.

Using the performance model outlined above in connection with Eqs. 1-3, and the knowledge on the number of map and reduce slots (S_{M}^{J}^{ᵢ}, S_{R}^{J}^{ᵢ}) allocated for the execution of job Jᵢ in the Pig program P, the lower bound of completion time of each job Jᵢ within the program P can be approximated as a function of (S_{M}^{J}^{ᵢ}, S_{R}^{J}^{ᵢ}) (i=1, . . . , |P|).

$${T}_{{J}_{i}}^{low} ( {S}_{M}^{{J}_{i}} , {S}_{R}^{{J}_{i}} ) = \frac{{A}_{{J}_{i}}^{low}}{{S}_{M}^{{J}_{i}}} + \frac{{B}_{{J}_{i}}^{low}}{{s}_{R}^{{J}_{i}}} + {C}_{{J}_{i}}^{low} . \qquad ( Eq . 5 )$$

The overall completion time of the program P is approximated as a sum of completion times of all the jobs that constitute P:

T_{P}^{low}=Σ_{1≦i≦|P|}T_{J}_{ᵢ}^{low}(S_{M}^{J}^{ᵢ}, S_{R}^{J}^{ᵢ}) (Eq. 6)

The computation of the estimates of overall completion time based on different bounds (T_{P}^{up} and T_{P}^{avg}) are handled similarly: the respective performance models are used for computing T_{J}^{up} or T_{J}^{avg} for each job Jᵢ(1≦i≦|P|) that constitutes the program P, which can then be used to compute the overall time upper bound or average estimate T_{J}^{up} or Tⱼ^{avg}, respectively, similar to Eq. 6.

Consider a program P={J₁, J₂, . . . J_{|P|}} with a given completion time goal D. The problem to be solved is to estimate the resource allocation (the set of map and reduce slots allocated to P during its execution) that enable the program P to be completed within deadline D.

There are several choices for determining the resource allocation for the program P. These choices are driven by the selection of which of the upper, lower, or average bound to use in the bound-based performance model of Eqs. 5 and 6.

A first choice involves determining the resource allocation when deadline D is targeted as a lower bound of the program completion time. This can lead to the least amount of resources that are allocated to the program P for finishing within deadline D.

A second choice involves determining the resource allocation when deadline D is targeted as an upper bound of the program completion time. This can lead to a more aggressive resource allocations and might result in a program completion time that is smaller (better) than D.

A third choice involves determining the resource allocation when deadline D is targeted as the average between lower and upper bounds on the program completion time. This solution may provide a balanced resource allocation that is closer for achieving the program completion time D.

For example, when D is targeted as a lower bound of the program completion time, a strategy according to some implementations is to pick a set of job completion times Dᵢ for each job Jᵢ from the set P={J₁, J₂, . . . , J_{|P|}} such that Σᵢ₌₁^{|P|}Dᵢ=D (in other words, the sum of the job completion times Dᵢ for the |P| jobs of the program P is equal to the overall program completion time D). The following set of equations based on Eq. 5 for an appropriate pair (S_{M}ⁱ, S_{R}ⁱ) of map and reduce slots for each job Jᵢ in the DAG can be solved:

$$[ \begin{matrix}\frac{{A}_{1}}{{S}_{M}^{{J}_{1}}} + \frac{{B}_{1}}{{S}_{R}^{{J}_{1}}} + {C}_{1} = {D}_{1} \\ \frac{{A}_{2}}{{S}_{M}^{{J}_{2}}} + \frac{{B}_{2}}{{S}_{R}^{{J}_{2}}} + {C}_{2} = {D}_{2} \\ ⋮ \\ \frac{{A}_{\vert P \vert}}{{S}_{M}^{{J}_{\vert P \vert}}} + \frac{{B}_{\vert P \vert}}{{S}_{R}^{{J}_{\vert P \vert}}} + {C}_{\vert P \vert} = {D}_{\vert P \vert}\end{matrix} ] , \qquad ( Eq . 7 )$$

where Aᵢ=A_{J}^{ᵢ}^{low}·N_{M}^{J}^{ᵢ}, Bᵢ=B_{J}^{ᵢ}^{low}·N_{R}^{J}^{ᵢ} and C_{J}^{ᵢ}^{low}.

Solving the foregoing set of equations can result in allocations of different numbers of map slots and reduce slots for the collection of jobs that make up the program P.

In alternative implementations, instead of computing potentially different numbers of map and reduce slots for different jobs that make up the program P, a different solution can determine an allocation of map and reduce slots (S_{M}^{P}, S_{R}^{P}) to be allocated to the entire program P—in other words, a single pair of a number of map slots and a number of reduce slots (S_{M}^{P}, S_{R}^{P}) is allocated to each job Jᵢ in P, 1≦i≦|P| such that P would finish within a given deadline D. Specifically, Eq. 7 can be rewritten with the condition S_{M}^{J}^{₁}=S_{M}^{J}^{₂}= . . . =S_{M}^{J}^{ᵢ}^{|P|}=S_{M}^{P} and S_{R}^{J}^{₁}=S_{R}^{J}^{₂}= . . . =S_{R}^{J}^{_{|P|}}=S_{R}^{P} as

$$\frac{{\sum }_{1 \leq i \leq \vert P \vert} {A}_{i}}{{S}_{M}^{P}} + \frac{{\sum }_{1 \leq i \leq \vert P \vert} {B}_{i}}{{S}_{R}^{P}} + {\sum }_{1 \leq i \leq \vert P \vert} {C}_{i} = D \qquad ( Eq . 8 )$$

Eq. 8 assumes that each job Jᵢ in program P is assigned the same number of map slots and same number of reduce jobs, such that instead of solving for |P| individual allocations of map slots and reduce slots to the |P| jobs in the program P, just one allocation of map slots and reduce slots is performed for the |P| jobs of the program P. Eq. 8 thus effectively aggregates performance parameters of corresponding individual ones of the jobs in the program.

Eq. 7 or 8 can be solved using a number of different techniques. In some implementations, a Lagrange's multipler technique can be used to allocate a minimum amount of resources (a pair of map and reduce slots (S_{M}^{P}, S_{R}^{P}) that results in the minimum sum of the map and reduce slots) for allocation to the program P for completing with a given deadline D.

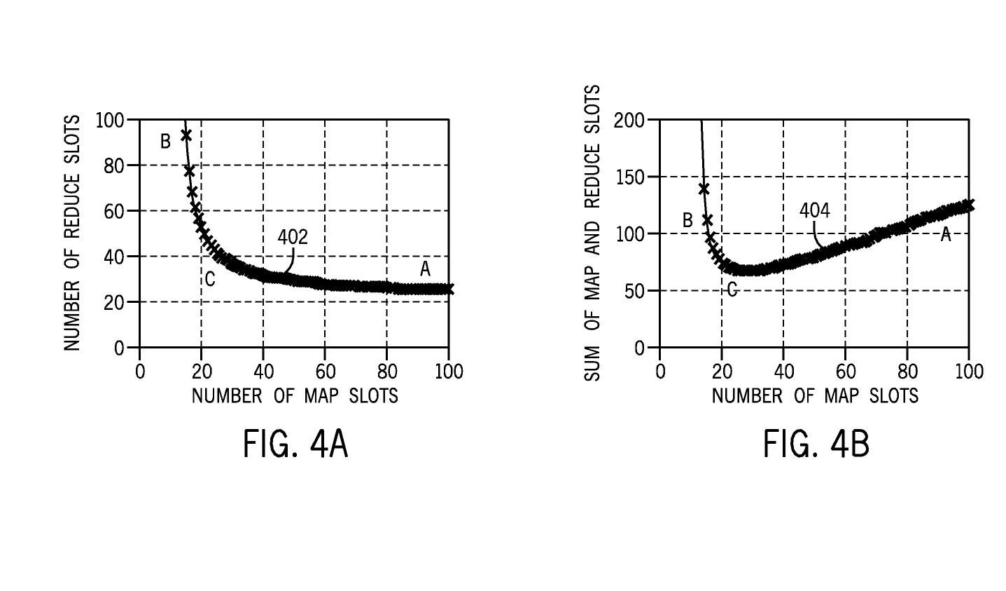

As shown in FIG. 4A, Eq. 8 yields a curve 402 if S_{M}^{P} and S_{R}^{P} (number of map slots and number of reduce slots, respectively) are the variables. All points on this curve 402 are feasible allocations of map and reduce slots for program P which result in meeting the same deadline D. As shown in FIG. 4A, allocations can include a relatively large number of map slots and very few reduce slots (shown as point A along curve 402) or very few map slots and a large number of reduce slots (shown as point B along curve 402).

These different feasible resource allocations (represented by points along the curve 402) correspond to different amounts of resources that allow the deadline D to be satisfied. FIG. 4B shows a curve 404 that relates a sum of allocated map slots and reduce slots (vertical axis of FIG. 4B) to a number of map slots (horizontal axis of FIG. 4B). There is a point along curve 404 where the sum of the map and reduce slots is minimized (shown as point C along curve 404 in FIG. 4B). Thus, the resource allocator 116 (FIG. 1) aims to find the point where the sum of the map and reduce slots is minimized (shown as point C). By allocating the allocation with a minimum of the summed number of map slots and reduce slots, the number of map and reduce slots allocated to the program P is reduced to allow available slots to be allocated to other jobs.

The minima (C) on the curve 404 can be calculated using the Lagrange's multiplier technique, in some implementations. The technique seeks to minimize f(S_{M}^{P}, S_{R}^{P}) over S_{M}^{P}+S_{R}^{P} over Eq. 8.

The technique sets

$$Λ = {S}_{M}^{P} + {S}_{R}^{P} + λ \frac{a}{{S}_{M}^{P}} + λ \frac{b}{{S}_{R}^{P}} - D ,$$

where λ represents a Lagrange multiplier, a represents Σ_{1≦i≦|P|} Aᵢ in Eq. 8, and b represents Σ_{1≦i≦|P|} Bᵢ in Eq. 8.

Differentiating A, partially with respect to S_{M}^{P}, S_{R}^{P} and λ and equating to zero, the following are obtained:

$$\frac{\partial Λ}{\partial {S}_{M}^{P}} = 1 - λ \frac{a}{{( {S}_{M}^{P} )}^{2}} = 0 , \\ \frac{\partial Λ}{\partial {S}_{R}^{P}} = 1 - λ \frac{b}{{( {S}_{R}^{P} )}^{2}} = 0 , \\ and$$

$$\frac{\partial Λ}{\partial λ} = \frac{1}{{S}_{M}^{P}} + \frac{b}{{S}_{R}^{p}} - D = 0 ,$$

Solving the above three equations simultaneously, the variables S_{M}^{P} and S_{R}^{P} are obtained:

$${S}_{M}^{P} = \frac{\sqrt{a} ( \sqrt{a} + \sqrt{b} )}{D} , \\ {S}_{R}^{P} = \frac{\sqrt{b} ( \sqrt{a} + \sqrt{b} )}{D} .$$

These values for S_{M}^{P} (number of map slots) and S_{R}^{P} (number of reduce slots) reflect the optimal allocation of map and reduce slots for the program P such that the total number of slots used is minimized while meeting the deadline of the job. In practice, the S_{M}^{P} and S_{R}^{P} values are integers—hence, the values found by the foregoing equation are rounded up and used as approximations.

A solution when D is targeted as an upper bound or an average bound between lower and upper bounds of the program completion time can be found in a similar way.

Machine-readable instructions of modules described above (including 108, 116, 120, 130, and 140 of FIG. 1) are loaded for execution on a processor or processors, e.g. 124 in FIG. 1). A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
generating, by a system having a processor, a collection of jobs corresponding to a program, wherein the jobs include map tasks and reduce tasks, the map tasks producing intermediate results based on segments of input data, and the reduce tasks producing an output based on the intermediate results;
calculating, in the system, a performance parameter using a performance model based on characteristics of the jobs, a number of the map tasks in the jobs, a number of reduce tasks in the jobs, and an allocation of resources; and
determining, by the system using a value of the performance parameter calculated by the performance model, a particular allocation of resources to assign to the jobs of the program to meet a performance goal of the program.

2. The method of claim 1, wherein generating the collection of jobs comprises generating a representation of an ordered arrangement of the jobs.

3. The method of claim 2, wherein generating the representation comprises generating a directed acyclic graph of the jobs.

4. The method of claim 1, wherein the performance model calculates the performance parameter based on aggregating performance parameters of corresponding individual ones of the jobs, and wherein determining the particular allocation of resources comprises determining a number of resources to be used by each of the jobs of the collection.

5. The method of claim 1, wherein determining the particular allocation of resources comprises individually determining numbers of resources to be used by corresponding ones of the jobs of the collection.

6. The method of claim 1, wherein the performance goal is a completion time, and wherein the performance parameter is a time parameter.

7. The method of claim 1, wherein the performance parameter calculated by the performance model is one of a lower bound parameter, an upper bound parameter, and an intermediate parameter between the lower bound parameter and the upper bound parameter.

8. The method of claim 1, wherein generating the collection of jobs from the program comprise generating the collection of jobs from a Pig program.

9. The method of claim 1, wherein determining the particular allocation of resources comprises determining a number of map slots and a number of reduce slots, the map slots to perform map tasks, and reduce slots to perform reduce tasks.

10. The method of claim 9, wherein the number of map slots and the number of reduce slots are to be assigned to each of the jobs in the collection.

11. An article comprising at least one machine-readable storage medium storing instructions that upon execution cause a system to:
compile, from a program, a collection of jobs, wherein the jobs include map tasks and reduce tasks, the map tasks producing intermediate results based on segments of input data, and the reduce tasks producing an output based on the intermediate results;
provide a performance model to calculate a performance parameter based on characteristics of the jobs, a number of the map tasks in the jobs, a number of reduce tasks in the jobs, and an allocation of resources; and
determine, using a value of the performance parameter calculated by the performance model, a particular allocation of resources to assign to the jobs of the program to meet a performance goal of the program.

12. The article of claim 11, wherein the particular allocation of resources comprises a number of map slots and a number of reduce slots to be used by each of the programs in the collection.

13. The article of claim 11, wherein determining the particular allocation of resources uses a Lagrange's multiplier technique to compute a smallest sum of allocated resources.

14. The article of claim 11, wherein the performance parameter is based on a number of map tasks and durations of map tasks of each of the jobs, and on a number of reduce tasks and durations of reduce tasks of each of the jobs.

15. The article of claim 11, wherein the performance goal is a completion time, and wherein the performance parameter is a time parameter.

16. A system comprising:
worker nodes having resources; and
a resource allocator to:
use a performance model to calculate a performance parameter based on characteristics of a collection of jobs that make up a program, a number of map tasks in the jobs, a number of reduce tasks in the jobs, and an allocation of resources, wherein the jobs include the map tasks and the reduce tasks, the map tasks producing intermediate results based on segments of input data, and the reduce tasks producing an output based on the intermediate results; and
determine, using a value of the performance parameter calculated by the performance model, a particular allocation of resources to assign to the jobs of the program to meet a performance goal of the program.

17. The system of claim 16, wherein the particular allocation of resources includes a number of map slots to perform map tasks, and a number of reduce slots to perform reduce tasks.
